(19) United States
(12) Patent Application Publication
(10) Pub. No.: US 2026/0109406 A1
(43) Pub. Date: Apr. 23, 2026

(54) DASH CROSS MEMBER STRUCTURE FOR VEHICLE

(71) Applicants: Hyundai Motor Company, Seoul (KR); Kia Corporation, Seoul (KR)

(72) Inventors: Se Ho Ryu, Hwaseong-si (KR); Hyun Woo Baek, Hwaseong-si (KR)

(21) Appl. No.: 19/016,009

(22) Filed: Jan. 10, 2025

(30) Foreign Application Priority Data
Oct. 21, 2024 (KR) 10-2024-0143594

(51) Int. Cl. B62D 25/14

(52) U.S. Cl. CPC B62D 25/145

(57) ABSTRACT

A dash cross member structure for a vehicle can include a dash cross member outer located at a front of a dash panel and a dash cross member inner located at a rear of the dash panel. The dash cross member outer can include a dash cross member center and a dash cross member side. The dash cross member side can be curved downward in a direction toward the dash cross member center. The dash cross member inner can be located lower than the dash cross member outer. A rear lower member can be coupled to the dash cross member inner. The rear lower member can be coupled to a lower portion of a vehicle body. The rear lower member can be mounted lower than the dash cross member outer. A front side member can be coupled to the dash cross member outer.

### CROSS-REFERENCE TO RELATED APPLICATIONS

This application claims the benefit of and priority to Korean Patent Application No. 10-2024-0143594, filed on Oct. 21, 2024, the entire contents of which are incorporated herein by reference.

### TECHNICAL FIELD

The present disclosure relates to a dash cross member structure mounted to a front of an electric vehicle.

### BACKGROUND

Generally, front side members, arranged longitudinally at opposite front lateral sides of a vehicle body, are required to have a structure for protecting passengers from impact energy when the vehicle collides with an object.

FIG. 1A is a view illustrating a vehicle body according to the related art. FIG. 1B is a view illustrating a vehicle mounting therein a large-capacity battery according to the related art. FIGS. 1A and 1B show a vehicle body of a common vehicle, to which a bumper beam 1, crash boxes 3, side members 4, and aprons 2 are combined. As shown in FIGS. 1A and 1B, the vehicle body is required to have a structure for protecting passengers from impact energy when the vehicle collides with an object. Here, the front side members 4 play an important role as a shock absorber. The front side members 4 are the most important skeletal components constituting the front components of the vehicle and are rigid members on which an engine and other important components are mounted.

The front side members 4 are coupled respectively to the crash boxes 3, which are coupled to opposite sides of the rear end portion of the front bumper beam 1. Each of the front side members includes an impact absorbing portion for relieving the impact from impact energy and an invasion preventing portion for preventing the impact from invading into a passenger compartment.

Fuel economy regulations that become more stringent as years go by have facilitated development of electric vehicles by automakers. Environmentally friendly vehicles become increasingly wide spread according to support policies on environmentally friendly vehicles in worldwide countries in addition to such regulations. Also, competition for increasing traveling distance of environmentally friendly vehicles becomes intensified among the automakers. Accordingly, to enhance the traveling distance of an electric vehicle, which is a typical environmentally friendly vehicle, size of a battery mounted on the vehicle is increasingly enlarged, with the result that weight of the vehicle is inevitably increased.

Such increase in the weight of the vehicle definitely causes increase of impact energy in the event of a vehicle collision and hence may seriously affect safety of passengers. Also, in the case of electric vehicles, there are additional regulations related to battery fire, etc. that have to be considered when evaluating impact. Therefore, it is necessary to improve the collision performance.

Furthermore, the packaging trend of electric vehicles needs a short overhang and increased interior space, and from the perspective of the vehicle body, the impact absorption space is reduced, making it difficult to secure collision performance. Moreover, because the high-voltage battery is located at a lower portion of the vehicle body, when a sub-frame rear mount is detached due to a collision, the sub frame may hit the battery, and therefore, there is required a member structure configured to prevent the sub-frame rear mount from being detached and to improve collision performance.

The above information disclosed in this Background section is only for enhancement of understanding of the background of the present disclosure, and therefore it may contain information that does not form the prior art that is already publicly known, available, or in use.

### SUMMARY

The present disclosure relates to a dash cross member structure mounted to a front of an electric vehicle. More particularly, the present disclosure relates to a dash cross member structure configured such that an interior dash cross member is welded to an exterior dash cross member and a front side member is welded to a rear lower member to flexibly absorb impact in a vehicle collision.

An embodiment of the present disclosure has been developed in an effort to solve the above-described problems, and an embodiment of the present disclosure can provide a structure configured to absorb an impact in the event of a collision without decreasing the interior space of an electric vehicle.

An embodiment of the present disclosure can provide a structure having an increased rigidity and configured to prevent detachment of a sub-frame rear mount and to prevent impact energy from being transmitted to passengers.

The advantages of embodiments of the present disclosure are not necessarily limited to the foregoing, and other advantages of embodiments of the present disclosure not mentioned herein may be understood based on the following description, and may be understood through the example embodiments of the present disclosure.

To achieve said advantages, an embodiment of the present disclosure can provide a dash cross member structure for a vehicle including the following configurations.

In an embodiment of the present disclosure, a dash cross member structure for a vehicle may include a dash cross member outer located at a front of a dash panel, and a dash cross member inner located at a rear of the dash panel.

In an example embodiment of the present disclosure, the dash cross member outer may include a dash cross member center and a dash cross member side.

In an example embodiment of the present disclosure, the dash cross member side may be curved downward in a direction toward the dash cross member center.

In an example embodiment of the present disclosure, the dash cross member side may be welded to the dash cross member center.

In an example embodiment of the present disclosure, the dash cross member inner may be located lower than the dash cross member outer.

In an example embodiment of the present disclosure, the dash cross member structure may include a rear lower member coupled to the dash cross member inner.

In an example embodiment of the present disclosure, the rear lower member may be coupled to a lower portion of a vehicle body, and may be mounted lower than the dash cross member outer.

In an example embodiment of the present disclosure, the dash cross member structure may include a front side member coupled to the dash cross member outer.

In an example embodiment of the present disclosure, the dash cross member outer may be integrated such that connected surfaces therein are seamlessly bonded to each other.

In an example embodiment of the present disclosure, the dash cross member outer and the dash cross member inner may be welded to each other.

Other aspects and exemplary embodiments of the present disclosure are discussed infra.

It can be understood that the term “vehicle” or “vehicular” or other similar terms as used herein can be inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum), for example. As referred to herein, a hybrid vehicle can be a vehicle that has two or more sources of power, for example, a vehicle powered by both gasoline and electricity.

### BRIEF DESCRIPTION OF THE DRAWINGS

The above and other features of embodiments of the present disclosure will now be described in detail with reference to certain example embodiments illustrated in the accompanying drawings, which are given herein below by way of illustration, and thus are not necessarily limitative of the present disclosure, and in which:

FIG. 1A is a view illustrating a vehicle body according to the related art;

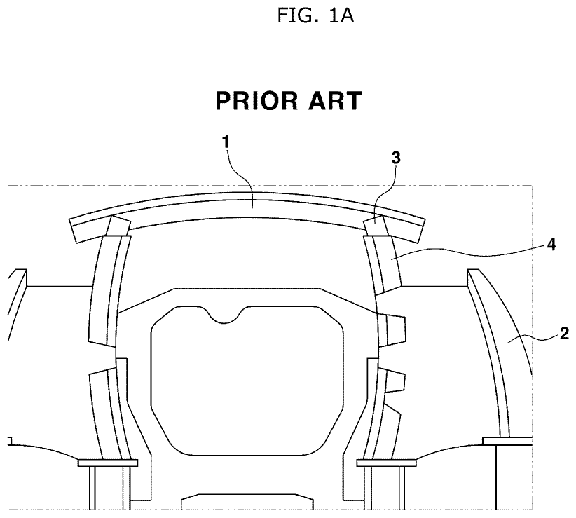

FIG. 1B is a view illustrating a vehicle mounting therein a large-capacity battery according to the related art;

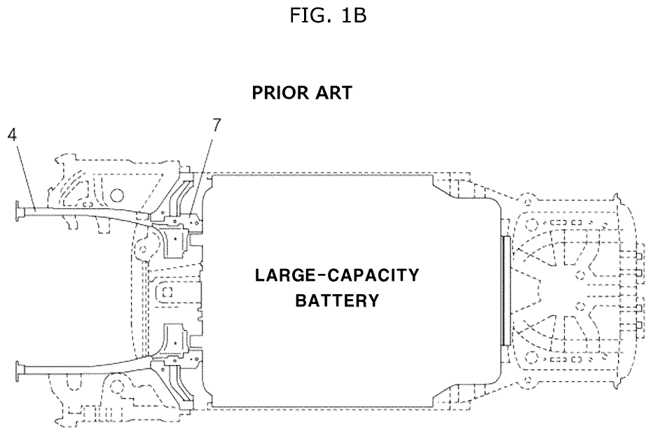

FIG. 2 is a whole perspective view illustrating a dash cross member structure for a vehicle according to an embodiment of the present disclosure;

FIG. 3 is a detailed exploded perspective view illustrating the overall components of a dash cross member structure for a vehicle according to an embodiment of the present disclosure;

FIG. 4 is a perspective view illustrating a dash cross member structure for a vehicle according to an embodiment of the present disclosure as viewed from the rear;

FIG. 5 is a view illustrating the connection of a dash cross member structure for a vehicle according to an embodiment of the present disclosure;

FIG. 6 is a view illustrating a welded portion in a dash cross member structure for a vehicle according to an embodiment of the present disclosure;

FIG. 7 is a view illustrating a dash cross member structure for a vehicle located at a pedals and feet area, according to an embodiment of the present disclosure;

FIG. 8 is a view to explain the positions of an interior dash cross member and an exterior dash cross member of a dash cross member structure for a vehicle according to an embodiment of the present disclosure;

FIG. 9 is a view to explain the positions of an interior dash cross member and an exterior dash cross member of a dash cross member structure for a vehicle, according to an embodiment of the present disclosure; and

FIG. 10A and FIG. 10B are views to explain an improved collision performance when an impact is applied to a dash cross member structure for a vehicle according to an embodiment of the present disclosure.

It can be understood that the appended drawings are not necessarily to scale, presenting a somewhat simplified representation of various features illustrative of some basic principles of example embodiments of the present disclosure. The specific design features of an embodiment of the present disclosure, including, for example, specific dimensions, orientations, locations, and shapes, can be determined in part by the particular intended application and usage environment.

In the figures, reference numbers refer to same or equivalent parts of example embodiments of the present disclosure throughout the several figures of the drawing.

### DETAILED DESCRIPTION OF ILLUSTRATIVE EMBODIMENTS

Hereinafter, example embodiments of the present disclosure will be described with reference to the accompanying drawings. The matters described in the attached drawings may be different from those actually implemented to facilitate description of some example embodiments of the present disclosure.

The terms “comprises” and/or “comprising” used in this specification mean that the cited component does not exclude the presence or addition of one or more of other components but may further comprise other components unless otherwise specified.

It can be understood that, when a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components can be interpreted in a like fashion (e.g., “between” versus “directly between,” “adjacent” versus “directly adjacent,” etc.).

Hereinafter, example embodiments will be described in detail with reference to the accompanying drawings, and in the description given with reference to the accompanying drawings, same or corresponding components can be assigned same reference numerals, and a description thereof will not be repeated.

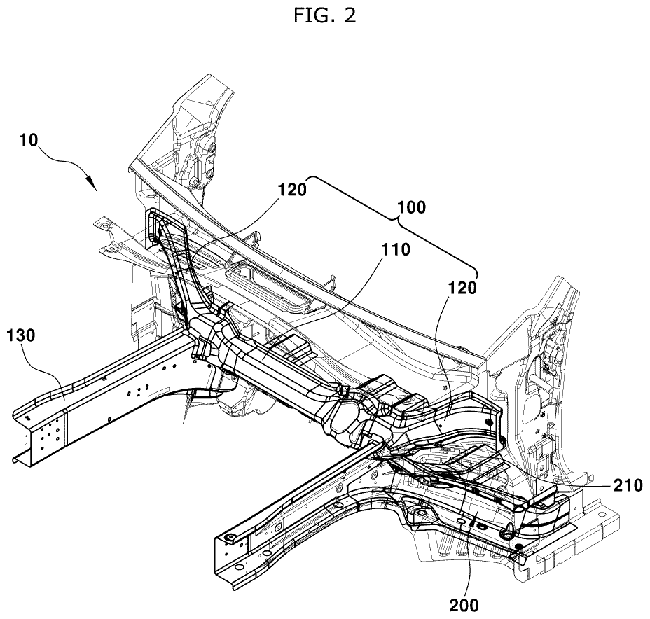

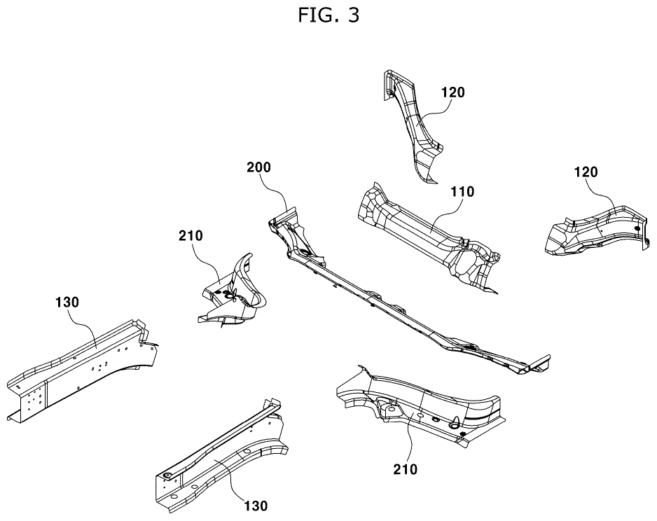

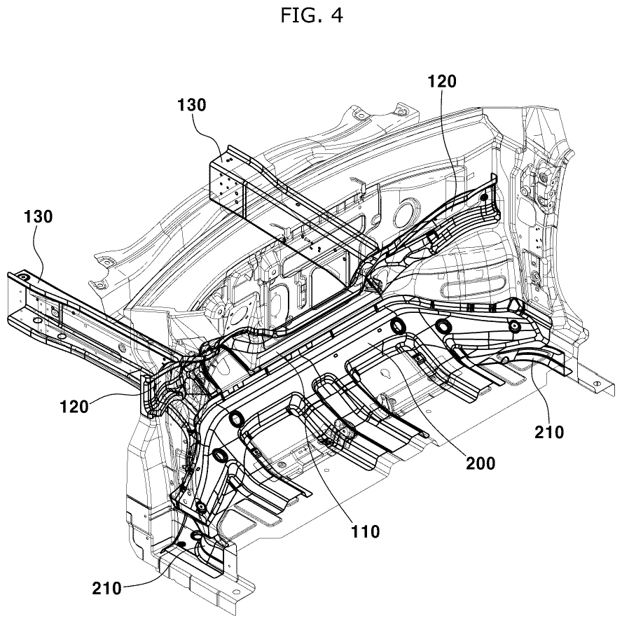

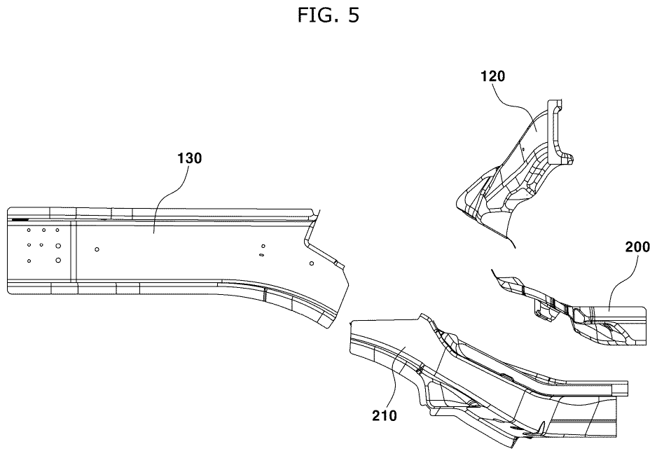

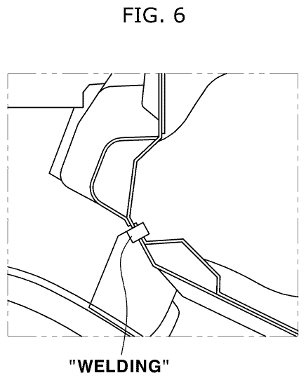

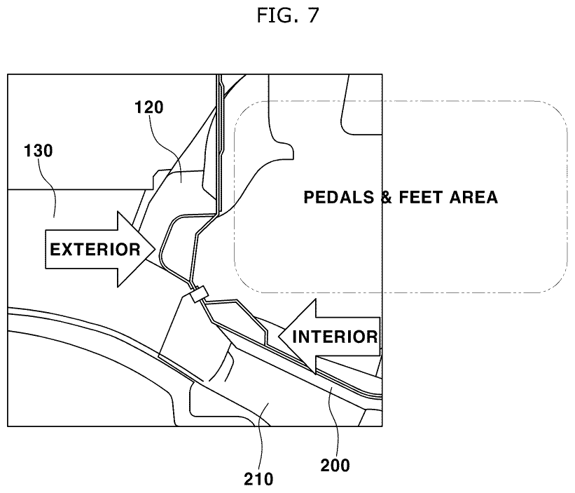

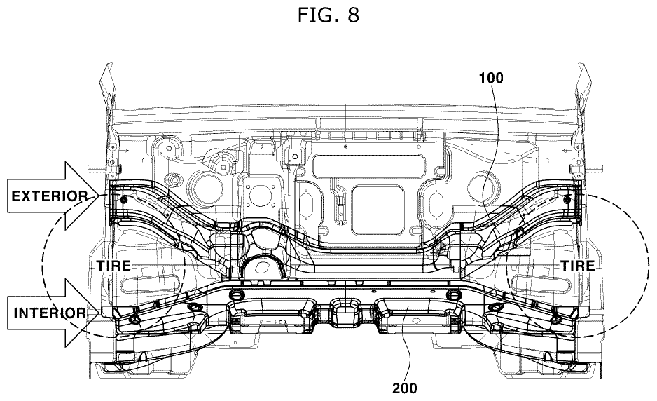

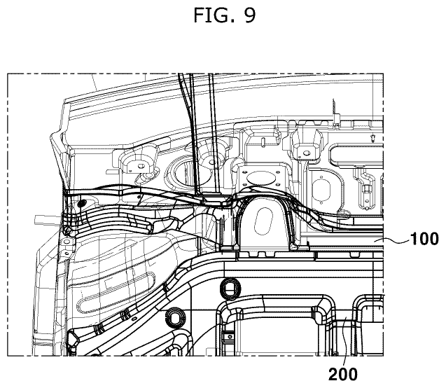

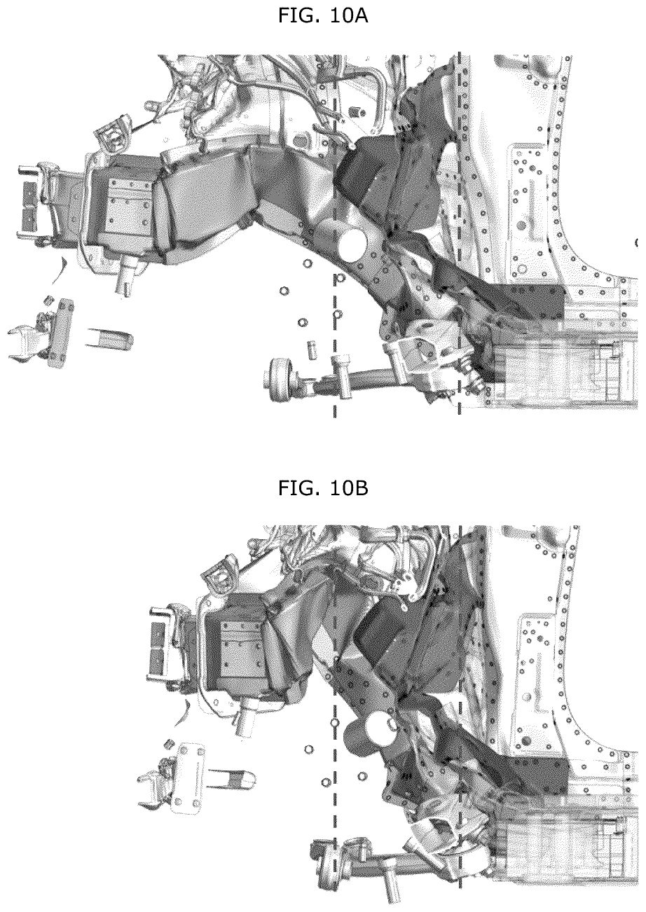

FIG. 2 is a whole perspective view illustrating a dash cross member structure for a vehicle according to an embodiment of the present disclosure. FIG. 3 is a detailed exploded perspective view illustrating the overall components of a dash cross member structure for a vehicle according to an embodiment of the present disclosure. FIG. 4 is a perspective view illustrating a dash cross member structure for a vehicle according to an embodiment of the present disclosure as viewed from the rear. FIG. 5 is a view illustrating the connection of a dash cross member structure for a vehicle according to an embodiment of the present disclosure. FIG. 6 is a view illustrating a welded portion in a dash cross member structure for a vehicle according to an embodiment of the present disclosure. FIG. 7 is a view illustrating a dash cross member structure for a vehicle located at a pedals and feet area. FIG. 8 is a view to explain the positions of an interior dash cross member and an exterior dash cross member of a dash cross member structure for a vehicle according to an embodiment of the present disclosure. FIG. 9 is a view to explain the positions of an interior dash cross member and an exterior dash cross member of a dash cross member structure for a vehicle. FIG. 10A and FIG. 10B are views to explain an improved collision performance when an impact is applied to a dash cross member structure for a vehicle according to an embodiment of the present disclosure.

Referring to FIGS. 2 to 4, a dash cross member structure 10 for a vehicle according to an example embodiment of the present disclosure can include a dual dash cross member structure in which the front and rear of a dash panel are each provided with a dash cross member.

A dash cross member structure 10 according to an example embodiment of the present disclosure can include a dash cross member outer 100 located at the front of the dash panel and a dash cross member inner 200 located at the rear of the dash panel. The dash cross member outer 100 and the dash cross member inner 200 may be welded to each other.

The dash cross member outer 100 may include a dash cross member outer center 110 and a dash cross member outer side 120, and the dash cross member inner 200 may include a rear lower member 210.

In other words, the dash cross member outer center 110 can be located at the front of a body frame and can be welded to the dash cross member side 120 to constitute the dash cross member outer 100. Specifically, the dash cross member outer center 110 can be located between the dash cross member outer side 120 provided as at least one or more pieces and the opposite ends of the dash cross member outer center 110 can be connected to the dash cross member outer side 120.

The dash cross member outer side 120 can be provided as at least one or more pieces, and may be coupled to and curved at the left and right sides of the dash cross member outer center 110. Differently put, the dash cross member outer side 120 may be curved downwards. More specifically, the dash cross member outer side 120 may be coupled to the opposite ends of the dash cross member outer center 110, respectively, and may be coupled to a front side member 130. Moreover, the dash cross member outer side 120, the dash cross member outer center 110, and the front side member 130 may be welded to one another to constitute the dash cross member outer 100 of the vehicle.

The dash cross member inner 200 may be located at the interior of the vehicle and may be located at a lower surface of the dash cross member outer center 110 that constitutes the dash cross member outer 100. Moreover, the opposite ends of the dash cross member inner 200 can be connected to the rear lower member 210 to constitute the dash cross member inner 200 of the vehicle.

The rear lower member 210 can be provided as at least one or more pieces and may be coupled to the left and right sides of the dash cross member inner 200. Specifically, the rear lower member 210 may be coupled to a lower portion of the vehicle body, and may be mounted lower than the dash cross member outer center 110 to disperse impact energy. Moreover, depending on the implementation, the rear lower member 210 may be manufactured to have a short length to easily secure the space of the electric vehicle platform.

The front side member 130 may be provided as one or more pieces. The end portion of the front side member 130 may be coupled to the left and right dash cross member outer sides 120, respectively, and may be welded to the dash cross member outer center 110 and to the dash cross member outer side 120 to constitute the dash cross member outer 100 of the vehicle. The front side member 130 can prevent the rigid bodies in the engine room from hitting the passenger space when a frontal collision occurs in the vehicle. The front side member 130 can be provided as at least one or more pieces to disperse impact energy, improving the safety of the passengers. The front side member 130 of an embodiment of the present disclosure can be manufactured to be a rectangular cross-section column because a rectangular cross-section column having a large contact area with a rigid body may have a greater capacity of absorbing impact energy compared to a circular cross-section column having the same cross-sectional area.

As such, in the dash cross member structure 10 for a vehicle according to an embodiment of the present disclosure, the dash cross member outer center 110, the dash cross member outer side 120 and the front side member 130 can be coupled to one another to constitute the dash cross member outer 100, the dash cross member inner 200 can have the rear lower member 210 coupled thereto, and the dash cross member outer 100 and the dash cross member inner 200 can be welded to each other.

Hereinafter, a process in which the dash cross member outer 100 and the dash cross member inner 200 of an embodiment of the present disclosure can be welded to each other is described sequentially with reference to at least FIGS. 5 to 9.

First, the dash cross member outer center 110 and the dash cross member outer side 120 can be welded to each other to constitute the dash cross member outer 100. Then, an end portion of the front side member 130 and the dash cross member outer 100 can be welded to each other. Next, the dash cross member inner 200 and the rear lower member 210 can be welded to each other. Finally, the dash cross member outer 100 and the dash cross member inner 200 can be welded together.

To elaborate on the welding portion in the dash cross member structure 10 by referring to FIG. 6, the ends of the dash cross member outer 100 and the dash cross member inner 200 may be welded to each other. Here, the dash cross member outer side 120 and the rear lower member 210 can be welded to each other, fundamentally blocking impact energy from being transmitted to the passengers and passenger compartment. By welding the dash cross member outer side 120 and the rear lower member 210 to each other, the rigidity of the dash cross member structure 10 may be increased.

To elaborate on the dash cross member structure 10 according to an embodiment of the present disclosure by referring to FIG. 7, the dash cross member structure 10 may be located at a position where pedals and feet area are mounted, i.e., at a lower portion of the vehicle. Considering the interior package layout and the gap with the tire, the dash cross member outer 100 may be located at an upper end portion of the vehicle and the dash cross member inner 200 may be located at a lower end portion of the vehicle. Because the rigidity of the dash cross member inner 200 can be improved, the high-voltage battery located at a lower portion of the vehicle may be protected, and the problem of the sub frame hitting the battery, which could occur when the sub-frame rear mount is detached in a collision, may be fundamentally eliminated.

A vehicle using the exterior dash cross member of the related art has somewhat reduced rigidity due to the connected surfaces in the member being separated, whereas, referring to FIGS. 8 and 9, the dash cross member outer center 110, the dash cross member outer side 120, and the front side member 130 according to an embodiment of the present disclosure can be welded to one another to implement an exterior dash cross member in which the connected surfaces therein are seamlessly bonded to each other, realizing the dash cross member structure 10 having an increased rigidity.

To describe the dash cross member structure 10 according to an embodiment of the present disclosure, which can have an improved collision performance when an impact or collision is applied, by referring to FIGS. 10A and 10B, when an impact or collision is applied to the vehicle, deformation of the side member begins in earnest as in FIG. 10A, but as in FIG. 10B, the side member is completely deformed but deformation of the passenger compartment is small.

As is apparent from the above description, an embodiment of the present disclosure may obtain the following advantages by the configuration, combination, and operation relationship described above with an embodiment of the present embodiment.

According to an embodiment of the present disclosure, a dash cross member structure for a vehicle can be configured to absorb an impact in the event of a collision without decreasing the interior space of an electric vehicle.

According to an embodiment of the present disclosure, a dash cross member structure for a vehicle can have an increased rigidity and can be configured to prevent detachment of a sub-frame rear mount and to prevent impact energy from being transmitted to passengers.

The above detailed description is illustrative of some example embodiments of the present disclosure. The above-described contents are to explain example embodiments of the present disclosure, and other embodiments of the present disclosure can be used in other various combinations, changes, and environments. That is, an embodiment of the present disclosure may be changed or modified within the scopes of the present specification, an equivalent scope to the present disclosure, and/or the scopes of technology or knowledge in the art. The example embodiments are illustrative of a best state for implementing a technical spirit of the present disclosure, and various modifications required in a detailed application field and purpose of the present disclosure can be possible. Thus, the above detailed description of the present disclosure is not to be construed as limited to the specific embodiments disclosed herein. Also, the attached claims can be interpreted to include other embodiments.

What is claimed is:

1. A dash cross member structure for a vehicle, the structure comprising:
a dash cross member outer located at a front of a dash panel; and
a dash cross member inner located at a rear of the dash panel.

2. The structure of claim 1, wherein the dash cross member outer comprises a dash cross member center and a dash cross member side.

3. The structure of claim 2, wherein the dash cross member side is curved downward in a direction toward the dash cross member center.

4. The structure of claim 2, wherein the dash cross member side is welded to the dash cross member center.

5. The structure of claim 1, wherein the dash cross member inner is located lower than the dash cross member outer.

6. The structure of claim 1, comprising a rear lower member coupled to the dash cross member inner.

7. The structure of claim 6, wherein the rear lower member is coupled to a lower portion of a vehicle body, and is mounted lower than the dash cross member outer.

8. The structure of claim 1, comprising a front side member coupled to the dash cross member outer.

9. The structure of claim 1, wherein the dash cross member outer is integrated such that connected surfaces therein are seamlessly bonded to each other.

10. The structure of claim 1, wherein the dash cross member outer and the dash cross member inner are welded to each other.

11. A dash cross member structure for a vehicle, the structure comprising:
a dash cross member outer located at a front of a dash panel, wherein the dash cross member outer comprises a dash cross member center and a dash cross member side, wherein the dash cross member side is curved downward in a direction toward the dash cross member center;
a dash cross member inner located at a rear of the dash panel, wherein the dash cross member inner is located lower than the dash cross member outer;
a rear lower member coupled to the dash cross member inner, wherein the rear lower member is coupled to a lower portion of a vehicle body, and wherein the rear lower member is mounted lower than the dash cross member outer; and
a front side member coupled to the dash cross member outer.

12. The structure of claim 11, wherein the dash cross member side is welded to the dash cross member center.

13. The structure of claim 11, wherein the dash cross member outer is integrated such that connected surfaces therein are seamlessly bonded to each other.

14. The structure of claim 11, wherein the dash cross member outer and the dash cross member inner are welded to each other.

15. The structure of claim 11 made according to a method comprising:
welding the dash cross member outer center to the dash cross member outer side to form the dash cross member outer;
welding the dash cross member outer to an end portion of the front side member;
welding the rear lower member to the dash cross member inner; and
welding the dash cross member outer and the dash cross member inner together to form the dash cross member structure.

16. The method of claim 15, wherein the dash cross member outer is integrated such that connected surfaces therein are seamlessly bonded to each other.

17. A method of making a dash cross member structure for a vehicle, the method comprising:
welding a dash cross member outer center to a left dash cross member outer side and t0 a right dash cross member outer side, to form a dash cross member outer;
welding the dash cross member outer to a first end portion of a left front side member and to a second end portion of a right front side member;
welding a rear lower member to a dash cross member inner;
welding the dash cross member outer and the dash cross member inner together to form the dash cross member structure.

18. The method of claim 17, wherein the welding of the dash cross member outer center to the left dash cross member outer side and t0 the right dash cross member outer side, to form the dash cross member outer, is performed first as a first operation;
wherein the welding of the dash cross member outer to the first end portion of the left front side member and to the second end portion of the right front side member, is performed second as a second operation after the first operation;
wherein the welding of the rear lower member to the dash cross member inner is performed third as a third operation after the second operation; and
wherein the welding of the dash cross member outer and the dash cross member inner together is performed fourth as a fourth operation after the third operation.

19. The method of claim 17, wherein the dash cross member outer is integrated such that connected surfaces therein are seamlessly bonded to each other.
